(19) United States
(12) Patent Application Publication
(10) Pub. No.: US 2006/0253413 A1
(43) Pub. Date: Nov. 9, 2006

(54) Method and system for transmitting user data to a terminal that has data service capability and is integrated in a communication network

(76) Inventors: Klaus-Dieter Dihlmann, Muenster-Altheim (DE); Hans-Georg Hellenthal, Koeln (DE)

Correspondence Address: KENYON & KENYON LLP, ONE BROADWAY, NEW YORK, NY, 10004, US

(21) Appl. No.: 11/285,828

(22) Filed: Nov. 23, 2005

(30) Foreign Application Priority Data
Nov. 24, 2004 (DE) 102004056513.9

(51) Int. Cl. G06F 17/30

(52) U.S. Cl. 707/1

(57) ABSTRACT

A method and system are provided for transmitting user data to a terminal that has data service capability, is integrated in a communication network, and in which the user data are retrievably stored. Desired user data is obtained from a user-data information system likewise connected to the communication network. It is connected in a manner that, starting from the terminal, the desired user data are requested from the user-data information system via the communication network, and the desired user data are subsequently transmitted by way of a standardized data service via communication network to the terminal for retrievable storage.

### FIELD OF THE INVENTION

The present invention relates to a method and a system for transmitting user data to a terminal that has data service capability, is integrated in a communication network, and in which the user data can then be retrievably stored.

### RELATED TECHNOLOGY

German reference DE 197 24 901 A1 appears to describe a terminal having data service capability, in the form of a mobile telephone which, as customary, has an interchangeable chip card for data storage. The terminal is usable for wireless communication within a communication network according to the type of a GSM network. User data, such as telephone numbers and address data, are able to be input directly via a keypad of the mobile telephone and can be stored on the chip card. The mobile telephone also has a connection interface for a computer. For example, an RS 232-interface may be used here as connection interface; the computer may be a customary PC. User data may be loaded into the mobile telephone via a line connection between the computer and the mobile telephone. This eliminates the need to painstakingly input user data via an inconvenient keypad in conjunction with the quite small graphic display unit of the mobile telephone. The user data are usually able to be edited via a telephone directory function of the mobile telephone.

It may be that the editing of user data with the aid of a computer connected to the mobile telephone provides greater ease of operation; however, when manually entering user data, for example, call numbers, at the computer, erroneous inputs may occur, resulting in useless user data in the terminal.

Further, at present, one may obtain user data from an information service provider present on the Internet via a computer connected to the Internet. The user data able to be procured are usually available in a program format requiring post-processing to enable the user data to be input via the computer into the terminal connected to it. However, this can be quite time-consuming and requires an Internet connection.

### SUMMARY OF THE INVENTION

The application area of the present invention extends to data-service-capable terminals of different communication networks such as fixed telecommunications networks or mobile telephony networks. Within the scope of the present invention, a terminal having data service capability is to be understood as a terminal—such as a telephone, fax machine or PDA (personal digital assistant)—which is able to exchange information via a standardized data service. To be understood by a standardized data service in this context is a messaging service, for example, SMS (short messaging service) or MMS (multimedia messaging service). The term user data used here is defined as person-specific information in data form about a subscriber as user of the communication network, and includes information about name, address, birth date, call number or fax number of the subscriber. The person-specific information may also include images, sounds and the like.

Embodiments of the present invention provide a method and a system for transmitting user data to a terminal, by which consistent user data for a desired subscriber may easily be retrievably stored directly in the electronic telephone directory of the terminal.

Some embodiments of the present invention involve a method for transmitting user data to a terminal that has data service capability, is integrated in a communication network, and in which the user data are retrievably stored, wherein desired user data are obtained from a user-data information system likewise connected to the communication network in that, starting from the terminal, the desired user data are requested from the user-data information system via the communication network, and the desired user data are subsequently transmitted by way of a standardized data service via communication network to the terminal for retrievable storage.

Some embodiments of the present invention involve a system for transmitting user data to a terminal that has data service capability, is integrated in a communication network, and in which the user data are retrievably stored, wherein the terminal obtains the desired user data from a user-data information system likewise connected to the communication network, in that the terminal requests the desired user data via the communication network from the user-data information system, which subsequently transmits the desired user data by way of a standardized data service via communication network to the terminal for retrievable storage.

Some embodiments of the present invention include the technical teaching that desired user data may be obtained from a user-data information system connected to a communication network, in a manner that, starting from the terminal, the desired user data are requested via the communication network from the user-data information system, and subsequently sent by way of a standardized data service (e.g., SMS, MMS) via the communication network to the terminal for retrievable storage.

In some embodiments of the present invention, as a rule, the user data now obtained externally from an information service provider are up-to-date and consistent. Input errors by the subscriber are thus ruled out. Moreover, it requires far less effort by the subscriber to obtain the desired user data. Only a suitable query from the terminal via the communication network may be necessary for this purpose, and a brief time later, after return reply, the desired user data are available for the subscriber. Permanent availability in the terminal may be ensured by the retrievable storage. Thus, the design approach of some embodiments of the present invention makes it possible, via an information service provider that for the most part possesses all user data, to transmit it in a form that permits a terminal to store this transmitted user data directly in the memory of an available telephone directory specific to the terminal. Consequently, the subscriber using the terminal may no longer need to undertake a very time-consuming and, from the view of the graphical user interface, very inconvenient and unclear editing of user data on his/her terminal him/herself, using difficult key combinations.

As discussed, in some embodiments, the user-data information system is able to utilize the standardized SMS or MMS data service for transmitting the user data to the terminal. In embodiments, it is also possible to use other suitable data services for this purpose. Desired user data may be requested either by telephone or likewise via a data service by way of the terminal to the user-data information system. In the first case, the subscriber using the terminal thus has the possibility of calling the information service provider, in turn informing it of his/her desired user data, which are then sent directly to the subscriber's terminal, e.g., by SMS data service. In the latter case, this query to the information service provider may be made via SMS or the like.

For example, in the latter case, for the query via data service, one may use the so-called Calling Line Identification Presentation (“CLIP”) information of an incoming call at the terminal. Thus, if a terminal receives a call request with associated call number (CLIP), which could not be accepted by the subscriber and was entered in a caller list of the terminal and cannot be assigned to any subscriber (i.e., any person already stored in the telephone directory of the terminal), then using this CLIP information, one may make a user-data inquiry at the information service provider. This functionality may be implemented in the graphical user interface of the terminal in such a way that the impetus for the request for user data at the information service provider only has to be confirmed with a key actuation. This further development allows convenient procurement of user data.

According to a further embodiments of the present invention, the user data received by the terminal are stored with an option settable at the terminal of automatic message or storage to be acknowledged beforehand by the subscriber. Thus, the subscriber using the terminal has the possibility of selecting one of the two storage options by way of a menu-driven setting of his/her terminal. In the case of automatic storage of the user data received by the terminal, no previous approval for the data acceptance is demanded of the subscriber via the graphic user interface. In this connection, a performed, automatic takeover of user data may at least be communicated via the graphic user interface and/or a sound signal. In the case of storage of user data received by the terminal to be acknowledged beforehand by the subscriber, the subscriber has the possibility of satisfying him/herself about the plausibility and completeness of the user data received by the terminal.

With regard system engineering, the terminal may be in communication with the communication network via a private telecommunications switching system. Private telecommunications switching system in this connection is a communication unit whose base station is in communication with the communication network, e.g., an ISDN network, and by which a plurality of terminals such as cordless telephones, fax machines and the like are operable. In this respect, an embodiment method of the present invention for transmitting user data to a terminal is carried out via the private telecommunications switching system, which, in this case, must likewise have data service capability.

According to a further embodiment of the present invention, the user data centrally stored in the base station of the private telecommunications switching system are also transmittable via the standardized data service or in another manner to the inquiring terminal. Thus, in a simple manner, all terminals linked to the private telecommunications switching system are able to obtain the user data stored herein.

According to a further embodiment of the present invention, the user-data information system may include an information service unit having data service capability, e.g., a computer system, with connected user-data database of an information service provider. The user-data information system is linked to the communication network via the data-service-capable information service unit. In this connection, the data-service-capable information service unit may include an SMS/MMS service center of a telecommunications service provider or at least be in communication with it, in order to implement the transmission of user data via standardized data service from the standpoint of system engineering. Both alternatives may guarantee a simple interaction of the user-data information system with an SMS/MMS service center. Thus, e.g., if the SMS/MMS service center receives an SMS or MMS as query for desired user data, it is relayed to the linked user-data information system. In the user-data information system, a search mechanism is thereupon started with access to the linked user-data data base. For this, it is of course necessary that all user data be stored in the form of defined data records in a manner able to be searched in the user-data data base. If the user data matching the query are found, the user-data information system sends the data with the corresponding parameters to the SMS/MMS service center which generates an SMS/MMS therefrom and sends it to the information-seeking terminal.

Embodiments of the present invention also may provide that the user-data information system utilizes the standardized SMS or MMS data service for transmitting the user data to the terminal. Embodiments also may provide that the subscriber requests desired user data by telephone, by a call via the terminal to the user-data information system. Embodiments also may provide that a standardized SMS or MMS data service is used by the terminal for transmitting the request for desired user data to the user-data information system. Embodiments also may provide that the CLIP information of a call incoming at the terminal is used for the query for desired user data. Embodiments also may provide that the user data received by the terminal are stored with an option, settable at the terminal, of automatic storage or storage to be confirmed by the subscriber beforehand.

Embodiments of the present invention may also include a system for transmitting user data to a terminal that has data service capability, is integrated in a communication network, and in which the user data are retrievably stored. The terminal obtains the desired user data from a user-data information system likewise connected to the communication network, in that the terminal requests the desired user data via the communication network from the user-data information system, which subsequently transmits the desired user data by way of a standardized data service via communication network to the terminal for retrievable storage. Embodiments also may provide that the user data are made up of person-specific information, selected from a group containing information about names, address data, birthday data, call numbers and/or fax numbers of a subscriber. Embodiments also may provide that for retrievable storage of the received user data, the data-service-capable terminal is equipped with a menu-driven telephone directory function able to be displayed on a display. Embodiments also may provide that the data-service-capable terminal is in the form of a wire-bound/wireless fixed-network telephone, a fax machine, a cellular phone or a PDA. Embodiments also may provide that the terminal is in communication with the communication network via a private telecommunications switching system. Further embodiments provide that the user data centrally stored in a base station of the private telecommunications switching system are transmittable via the standardized data service to the inquiring terminal. Embodiments also may provide that the user-data information system includes a data-service-capable information service unit with connected user-data data base of an information service provider, which is in communication with the communication network. Embodiments also may provide that the user-data information system includes an SMS/MMS service center or is in communication with it. Embodiments also may provide that the communication network is a fixed network or a mobile telephony network of a telecommunications network operator.

### BRIEF DESCRIPTION OF THE DRAWING

The FIGURE shows a block diagram of a system for transmitting user data to a terminal that has data service capability and is linked into a communication network.

### DETAILED DESCRIPTION

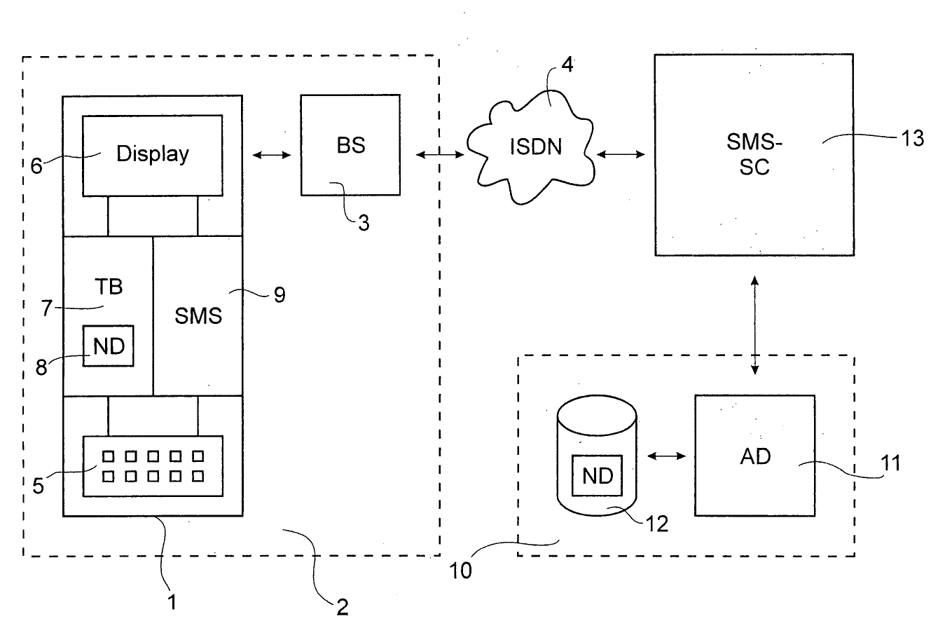

According to FIG. 1, a system for transmitting user data 8 includes a terminal 1 having data service capability, in the form of an ISDN fixed-network telephone, which is a component of a private telecommunications switching system 2 and is in communication with a base station 3 of private telecommunications switching system 2. Further terminals (not shown) are linked to base station 3 of private telecommunications switching system 2. Base station 3 is in communication with a communication network 4. In this exemplary embodiment, communication network 4 is an ISDN network (i.e., an integrated services digital network). Outgoing calls from terminal 1 are relayed via base station 3 to communication network 4. Depending on the call number, base station 3 automatically relays incoming calls from communication network 4 to correct terminal 1 or another.

Terminal 1 shown here by way of example includes a conventional, numeric keypad 5 as input unit, as well as a display 6 having a graphic user interface which displays the menu-driven functions of terminal 1. The menu-driven functions of terminal 1 are operated via keypad 5 in a manner known per se. The electronics integrated in terminal 1 include a telephone directory function 7. Using telephone directory function 7, user data such as name, address, and call number, of other subscribers are retrievably stored in terminal 1. User data stored by a user-data memory 8 are selected in menu-driven fashion via display 6 in cooperation with inputs via keypad 5.

Terminal 1 also includes an SMS function 9, by which—in a manner known per se—text messages to be input via keypad 5 may be sent from terminal 1 via communication network 4 to a terminal 1 of another subscriber.

According to the present invention, data-service-capable terminal 1 obtains desired user data from a user-data information system 10 likewise connected to communication network 4. In this embodiment, user-data information system 10 is made up essentially of an information service unit 11 having data service capability, with connected user-data data base 12 of an information service provider. User-data information system 10 is connected via information service unit 11 to an SMS service center 13, which in turn is in communication with communication network 4. Information service unit 11 includes a computer which, in accordance with incoming inquiries, procures the desired user data from user-data data base 12, in order to send this response back to inquiring terminal 1 via SMS service center 13 by SMS response.

The inquiry and the transmission of desired user data to terminal 1 are carried out in a manner that, starting from data-service-capable terminal 1, the desired user data are requested from user-data information system 10 via communication network 4. The CLIP information of a known call received at terminal 1 may be used for the query of desired user data, e.g., name and address of a subscriber. The call number—known based on the CLIP information—of the unknown subscriber is transmitted by SMS via communication network 4 to SMS service center 13. SMS service center 13 recognizes the incoming SMS as an inquiry for desired user data and relays the inquiry automatically to user-data information system 10. Information service unit 11 thereupon procures the desired user data from connected user-data data base 12 and sends the selected user data as response back to SMS service center 13. SMS service center 13 converts this information into an SMS and sends it back via communication network 4 to inquiring, data-service-capable terminal 1. For this, the SMS must have a special format, in order to be recognized independently by the terminal as data information. The requested user data, e.g., name and address, are now ready in data-service-capable terminal 1 for storage and further retrieval.

To identify an SMS containing user data, for the purpose of authentication of the information service provider, a special transmit call number is defined which, upon reception of the requested user data, signals to terminal 1 that the contents of the SMS are the user data requested at user-data information system 10. As an alternative, the contents of an SMS containing user data may also begin with a defined master-data parameter which causes data-service-capable terminal 1 to recognize the data following after the master-data parameter in the SMS as user data 8, to evaluate it and to retrievably store it in terminal 1.

The present invention is not limited to the exemplary embodiment described above. Rather, modifications thereof are also conceivable. Thus, for example, instead of the SMS data service, one may also use the MMS data service, inter alia, for transmitting user data. In this case, in the subject line of an MMS, a master-data parameter may be defined which causes the terminal to recognize the data files added to the MMS as user data. Moreover, the present invention is not restricted to a request for desired user data by way of data service. The request may also be made by telephone by a call via terminal 1 to user-data information system 10. In this case, the query must be accepted by a call center or a speech computer and processed accordingly. Finally, it should be pointed out that embodiments of the present invention may be used both for the fixed-network sector and for the mobile radiocommunications sector, and, for example, for voice-over IP, as well.

What is claimed is:

1. A method for transmitting user data to a terminal that has data service capability, is integrated in a communication network, and in which the user data are retrievably stored, comprising:
obtaining desired user data from a user-data information system connected to the communication network, including:
requesting the desired user data from the user-data information system via the communication network, and
subsequently transmitting the desired user data by a standardized data service via the communication network to the terminal for retrievable storage.

2. The method as recited in claim 1, wherein the user-data information system utilizes at least one of standardized SMS data service and standardized MMS data service for transmitting the user data to the terminal.

3. The method as recited in claim 1, wherein the subscriber requests desired user data by telephone, by a call via the terminal to the user-data information system.

4. The method as recited in claim 1, wherein the terminal uses at least one of standardized SMS data service and standardized MMS data service for transmitting the request for desired user data to the user-data information system.

5. The method as recited in claim 4, wherein the CLIP information of a call incoming at the terminal is used for the query for desired user data.

6. The method as recited in claim 1, wherein the user data received by the terminal are stored with an option, settable at the terminal, of automatic storage or storage to be confirmed by the subscriber beforehand.

7. A system for transmitting user data to a terminal that has data service capability, is integrated in a communication network, and in which the user data are retrievably stored,
wherein the terminal obtains the desired user data from a user-data information system likewise connected to the communication network, in that the terminal requests the desired user data via the communication network from the user-data information system, which subsequently transmits the desired user data by way of a standardized data service via communication network to the terminal for retrievable storage.

8. The system as recited in claim 7, wherein the user data are made up of person-specific information, selected from a group containing information about names, address data, birthday data, call numbers and/or fax numbers of a subscriber.

9. The system as recited in claim 7, wherein for retrievable storage of the received user data, the data-service-capable terminal is equipped with a menu-driven telephone directory function able to be displayed on a display.

10. The system as recited in claim 7, wherein the data-service-capable terminal is in the form of a wire-bound/wireless fixed-network telephone, a fax machine, a cellular phone or a PDA.

11. The system as recited in claim 7, wherein the terminal is in communication with the communication network via a private telecommunications switching system.

12. The system as recited in claim 7, wherein the user data centrally stored in a base station of the private telecommunications switching system are transmittable via the standardized data service to the inquiring terminal.

13. The system as recited in claim 7, wherein the user-data information system includes a data-service-capable information service unit with connected user-data data base of an information service provider, which is in communication with the communication network.

14. The system as recited in claim 7, wherein the user-data information system includes an SMS/MMS service center or is in communication with it.

15. The system as recited in claim 7, wherein the communication network is a fixed network or a mobile telephony network of a telecommunications network operator.
